(19) United States
(12) Patent Application Publication
(10) Pub. No.: US 2007/0068741 A1
(43) Pub. Date: Mar. 29, 2007

(54) Pressure sensor for automatic door

(76) Inventors: Dora Janos, Budapest (HU); Laszlo Keszthelyi, County of Queens, NY (US); Lovas Gabor, Godollo (HU); Soha Jozsef, Budapest (HU)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 11/402,038

(22) Filed: Apr. 11, 2006

Related U.S. Application Data
(60) Provisional application No. 60/720,920, filed on Sep. 27, 2005.

(51) Int. Cl. B66B 13/26

(52) U.S. Cl. 187/317

(57) ABSTRACT

A pressure sensor for automatic doors including at least one film pressure sensor layer and one or more first protective layer overlaying the film pressure sensor layer. The pressures sensor layer and first protective layer(s) are secured to the closing edge of an automatic door. The film pressure sensor layer includes two electrode films sandwiching a non-electrical conducting layer. When pressure is applied to the film pressure sensor layer such that the electrode films come into contact with each other, a sensor signal is generated to open the automatic door. Additional protective layers such as anti-penetration layer(s) and second protective layer(s) may be included with the pressure sensor. The pressure sensor may also include a pressure transfer element between the first protective layer(s) and the film pressure sensor layer(s) to provide effective pressure transfer.

This application claims the benefit of U.S. Provisional Application No. 60/720,920, filed Sep. 27, 2005.

### FIELD OF THE INVENTION

The invention relates to a sensor for automatic door(s). Specifically, it relates to a pressure sensor for use in connection with elevator door(s) to provide safety to users and to avoid interfering with the normal operation of elevators.

### BACKGROUND OF THE INVENTION

Automatic doors can be found at stores, elevators, garages, restaurants, etc. Although automatic doors are often for the convenience of users, automatic doors in an elevator is essential to prevent people from falling down an open shaft and to keep the people safely within an elevator car.

Elevator doors use two sets of doors—doors on the cars and outer doors opening into the elevator shaft. The doors on the elevators cars are typically automatic and are operated by an electric motor, which is controlled by a master control system that controls the movement of the elevators. Elevator doors are connected to a wheel driven by a motor through a series of linkage arms. When the motor turns the wheel one way, it causes the elevator doors to open; when the motor turns the wheel the other way, it causes the elevator doors to close. When the master control system senses the elevator car at a floor, the elevator doors open. Before the elevator starts moving again, the master control system closes the elevator doors. The elevator car doors have a clutch mechanism that interacts and unlocks the outer doors at each floor to open/close the outer doors simultaneously with the opening/closing of the elevator car doors. This prevents the outer doors from opening into an empty elevator shaft.

Automatic elevator doors have a safety feature that includes a sensor that prevents the elevator doors from closing if someone is between them. There are generally two types of prior art elevator door sensors—electromechanical sensors and electronic sensors. These sensors are typically located at the closing edge of the elevator door(s).

A prior art electromechanical sensor includes an elongated tongue that extends from the edge of the elevator door for the length of the door. If the elevator door is closing and the tongue senses a force applied to it, i.e., when a person touches or hits the tongue, then the mechanical retracting system will automatically trigger a micro-switch to activate the opening of the elevator door fully to prevent injury to the person entering/exiting the elevator. A disadvantage of such electro-mechanical sensor is if the required force to be applied to the tongue is large, then a user may be injured by the closing elevator doors before the electro-mechanical sensor is actuated.

A prior art electronic sensor, including infrared or photo sensors, provides a light source and a receiver across the elevator doors. If and when the light beam is broken, i.e., when a person is entering/exiting the elevator, the elevator door will fully open to prevent injury to the person. A disadvantage of such sensor is that if a user attempts to use a limb to break the light beam, which is located at distinct locations only, but fails to do so, the user may be injured by the closing elevator doors.

An elevator door sensor is an important safety feature of an elevator. The master control system typically prevents operation of the elevator if the system detects a fault, no matter how minor, with the sensor. Typically, an elevator door sensor does not have a back up sensor system. Often, an elevator is taken out of service solely because of the malfunctioning of the door sensor. Therefore, there is a need for an automatic door sensor that provides adequate safety for the users with minimal interference with the normal operation of elevators.

### SUMMARY OF THE INVENTION

The present invention is a pressure sensor for automatic door(s) for preventing injury to the user passing through the door(s).

In particular, the pressure sensor of the present invention includes at least one film pressure sensor layer and one or more first protective layer overlaying the film pressure sensor layer. The pressures sensor layer and first protective layer(s) are secured to the closing edge of an automatic door. The film pressure sensor layer includes two electrode films sandwiching a non-electrical conducting layer comprises a dielectric gel or an inert, non-corrosive, gas. When pressure is applied to the film pressure sensor layer such that the electrode films come into contact with each other, a sensor signal is generated to open the automatic door.

The pressure sensor may include additional protective layers such as anti-penetration layer(s) and second protective layer(s). Preferably, with the first protective layer(s) forming the closing edge of the door, the remaining layers are in the following order: anti-penetration layer(s), film pressures sensor layer(s) and second protective layer(s). The second protective layer can be secured to the closing edge of the door.

The pressure sensor may include a pressure transfer element between the first protective layer(s) and the film pressure sensor layer(s) to provide effective pressure transfer. The pressure transfer element has first and second convex surfaces, with the first convex surface corresponding to a concave inner surface of the first protective layer(s).

The pressure sensor of the present invention can be applied to all types of automatic doors, including elevator doors.

### BRIEF DESCRIPTION OF THE DRAWINGS

Preferred embodiments of the present invention have been chosen for purposes of illustration and description and are shown in the accompanying drawings forming a part of the specification wherein:

FIG. 1 shows a typical elevator with the pressure sensor of the present invention at the closing edge of the elevator doors.

FIG. 2 shows a basic pressure sensor of the present invention.

FIG. 3 shows a cross-sectional view of the film pressure sensor layer of the present invention.

FIG. 4 shows a cross-sectional view of another pressure sensor of the present invention.

FIG. 5 shows a schematic of the different functionalities available to the pressure sensor of the present invention.

### DETAILED DESCRIPTION OF THE PREFERRED EMBODIMENTS

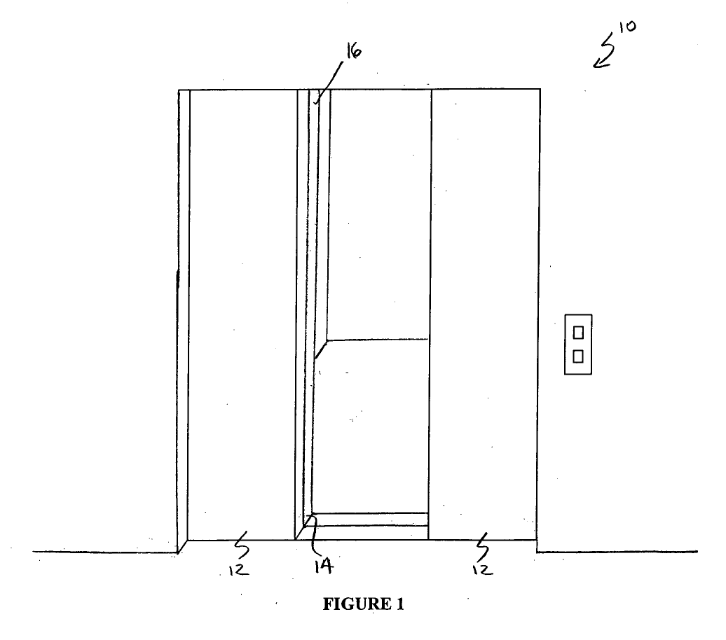

With reference to the drawing wherein the same reference number illustrates the same element throughout, FIG. 1 shows a typical elevator 10 with a pair of outer doors 12 and pair of elevator car doors 14. Along the closing edge of the elevator doors 14 is the pressure sensor 16 of the present invention. The pressure sensor 16 is a thin elongated strip attached to the closing edge of the elevator doors 14. The pressure sensor 16 may be attached to one or both elevator doors 14.

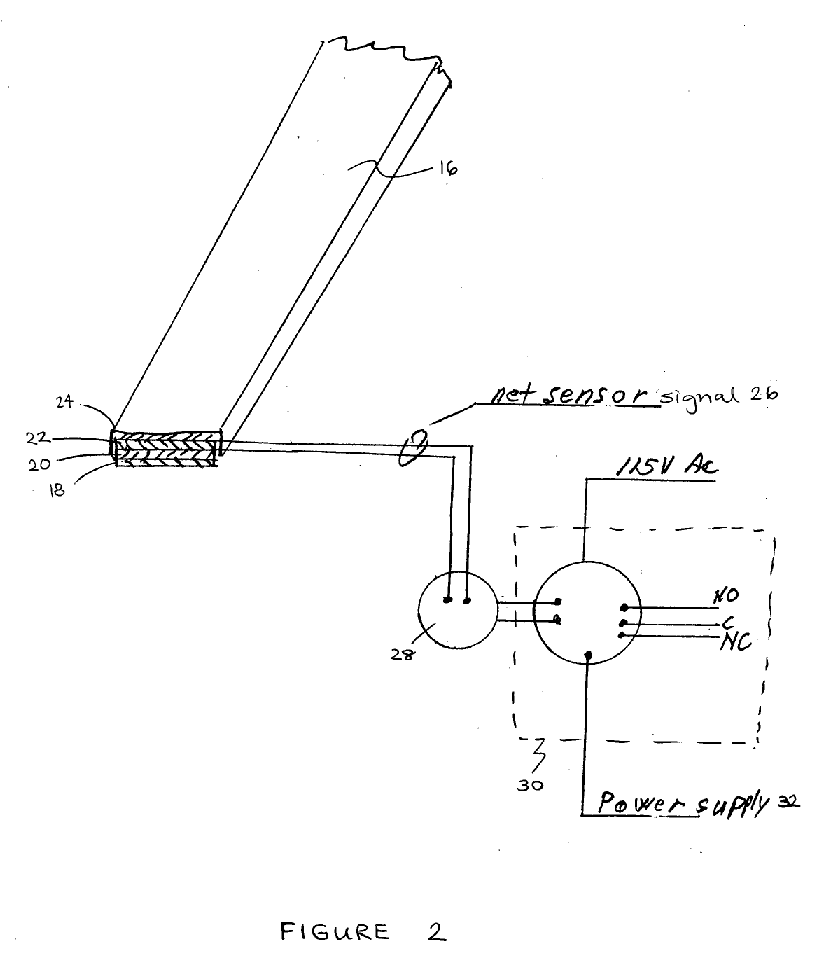

FIG. 2 shows a basic pressure sensor 16 of the present invention comprising a plurality of layers: one or more first protective layer 18, one or more anti-penetration layer 20, one or more film pressure sensor layer 22, and one or more second protective layer 24. The first protective layer 18, which will form the closing edge of the elevator door 14, may be made of rubber, soft neoprene, elastomer or vinyl. The material of the first protective layer 18 provides a cushioned edge and added protection to a user if it comes into contact with a user. The anti-penetration layer 20 may be made of KEVLAR®, SPECTRA®, or ZYLON® material or other anti-ballistic or anti-piercing material. The second protective layer 24 may be made of metal and abuts or mounts onto the elevator door 14. The pressure sensor 16 may be mounted onto the closing edge of the elevator door 14 by any fastening means such as adhesive, fasteners, etc., known to one skilled in the art.

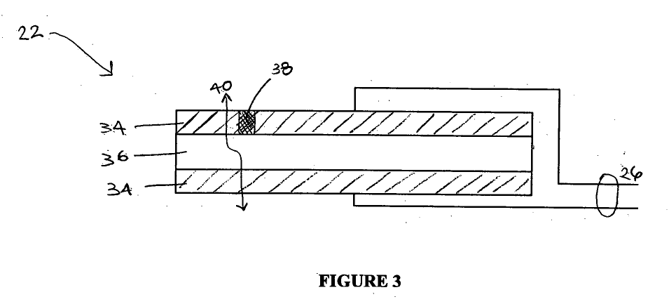

FIG. 3 shows the film pressure sensor layer 22, which comprises three layers, with two outer electrode films 34 sandwiching a dielectric gel layer 36. These three layers may be encapsulated in an encapsulating film (not shown). When the film pressure sensor layer 22 is pressurized, compressing the gel layer 36, a short is created between the two electrode films 34, and as shown in FIG. 2, a signal 26 is sent to the master control system 30. The signal 26 from the film sensor layer 22 is first amplified by an amplifier 28. The amplified signal 28 is then sent to the elevator master control system 30 to open the elevator doors 14. A power supply 32 provides electrical power to the pressure sensor 16, amplifier 28 and the master control system 30.

Due to the two dimensional layout of each electrode film 34, even if a small portion of the outer electrode film 34 is pierced or defective or otherwise malfunctioned (illustrated as 38), another path (illustrated as 40) is available between the electrode films 34 to create a short when pressure is applied. Therefore, a distinct failure or malfunctioned point will not interfere with the overall operation of the elevator 10 unless the entire electrode film 34 fails. The pressure sensor 16 of the present invention advantageously provides adequate safety to users and avoids interfering with the operation of the elevator 10.

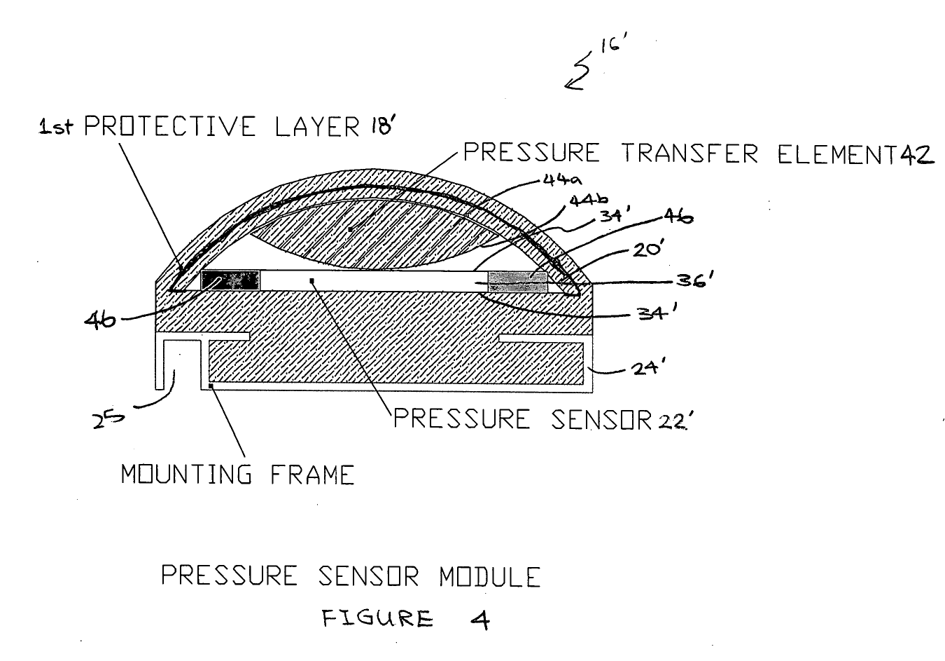

FIG. 4 shows another embodiment of a pressure sensor 16′ of the present invention comprising a plurality of layers: a first protective layer 18′, an anti-penetration layer 20′, a pressure transfer element 42, film pressure sensor layer 22′, and a second protective layer 24′.

The first protective layer 18′ may be made of rubber, soft neoprene, elastomer or vinyl, which acts as a cushioned closing edge of the elevator door 14. The anti-penetration layer 20′ may be made of KEVLAR®, SPECTRA®, or ZYLON® material or other anti-ballistic or anti-piercing material. The first protective layer 18′ and the anti-penetration layer 20′ preferably form an outer convex surface that provides a rounded and safer closing edge of the elevator door 14.

Under the first protective layer 18′ and the anti-penetration layer 20′ is a pressure transfer element 42 having opposite convex outer surfaces 44a and 44b. The upper outer surface 44a corresponds to the inner concave surface of the first protective layer 18′ and the anti-penetration layer 20′. The pressure transfer element 42 may be made of a hard elastomer, rubber or neoprene material that provides effective pressure transfer from the first protective layer 18′ and the anti-penetration layer 20′ to the film pressure sensor layer 22′.

Under the pressure transfer element 42 is the film pressure sensor layer 22′. The film pressure sensor layer 22′ comprises three layers, with two outer electrode films 34′ sandwiching a chamber 36′. The chamber 36′ may be filled with any inert, non-corrosive, gas such as nitrogen. To aid in sustaining the physical structure of the film pressure sensor layer 22′, at each elongated outer edge of the film pressure sensor layer 22′ is a spacer 46. The pressure transfer element 42 and film pressure sensor layer 22′ may both be encapsulated within the first protective layer 18′ and/or the anti-penetration layer 20′.

When pressure is applied to the first protective layer 18′, the pressure is transfer through the anti-penetration layer 20′ to the pressure transfer element 42 to cause one of the outer electrode films 34′ to come into contact with the other outer electrode films 34′ to create a short therebetween. The convex outer surface 44b of the pressure transfer element 42 is correspondingly sized and shaped to overlay the film pressure sensor layer 22′ to provide the most effective transfer of pressure applied to the pressure sensor 16′ from all angles. Similar to the film pressure sensor layer 22 shown in FIG. 3, when the two outer electrode films 34′ are shorted, a signal 26′ is generated and sent to the master control system 30′ of the elevator (not shown) to open the elevator doors 14.

The second protective layer 24′ may be made of metal to form a base for the pressure sensor 16′ so that the pressure sensor 16′ can be mounted onto the elevator door 14 by any fastening means such as adhesive, fasteners, etc., known to one skilled in the art. The flat surface of the protective layer 24′ allows the pressure sensor 16′ to be mounted onto any elevator door 14. The second protective layer 24′ of FIG. 4 includes an elongated groove 25 to accept a veneer covering (not shown) typically used to cover the elevator doors 14.

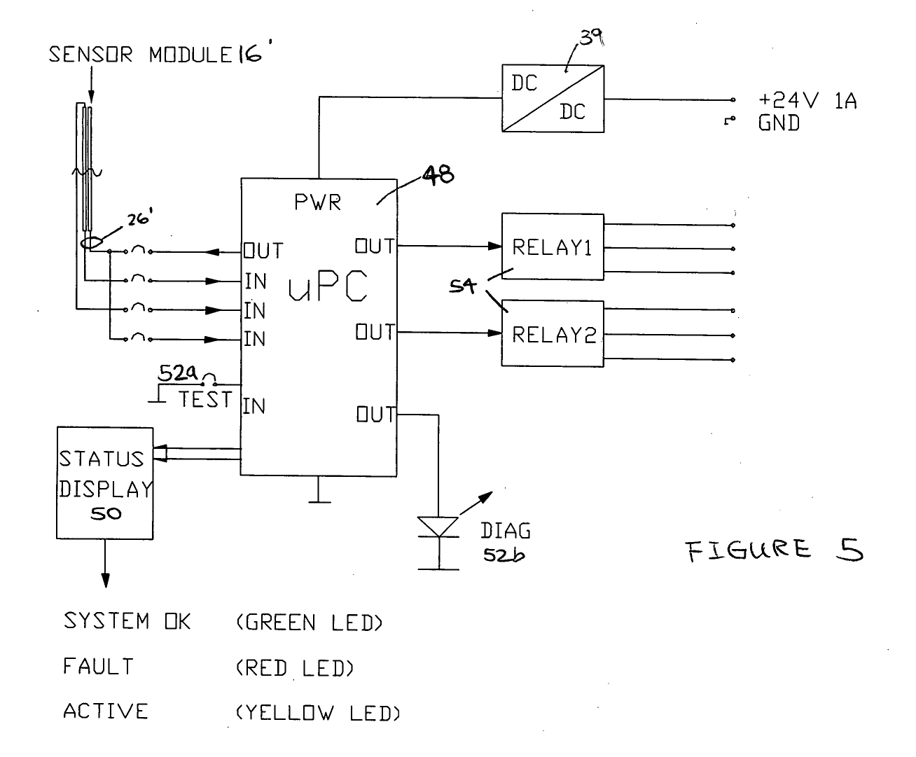

As shown in FIG. 5, the pressure sensor 16 or 16′ may alternatively be connected to a microprocessor 48 to provide additional functionalities. The microprocessor 48 includes a built-in amplifier such as 28 of FIG. 2 to properly amplify the signal going to the master control system 30′. The microprocessor 48 can be programmed to provide various functionalities such as status display 50, diagnostic 52, relay connections 54, etc. The microprocessor 48 can be powered by either a direct or alternating current power source 39. The power source 39 can either be independent or the same as that of the elevator 10, or master control system 30′.

The status display 50 includes one or more LEDs to indicate the status of the pressure sensor 16′. For example, a green LED indicates the pressure sensor 16′ is working properly; a red LED indicates a fault with the pressure sensor 16′ and a yellow LED indicates an active, but stand-by pressure sensor 16′. The status display 50 may be incorporated into the pressure sensor 16′ itself or located in the elevator control panel among other controls. Further, the status display 50 is connected to the master control system 30′ to provide real time status information of the pressure sensor 16′. If a fault is detected with the pressure sensor 16′, the master control system 30′ may halt the operation of the elevator 10 until the fault is corrected.

The function of diagnostic 52 can be achieved through connections 52a and 52b between the microprocessor 48 and the master control system 30′ for testing purposes.

The relay connections 54 allow each pressure sensor 16′ to be properly configured and selected to interact with different systems of different elevators.

The microprocessor 48 and the hardware for the additional functionalities 50, 52, and 54, can be very compact in size such that it can be incorporated into a small section of the pressure sensor 16′ itself, which can then be connected to the master control system 30′ either wirelessly or hard-wired. Alternatively, the microprocessor 48 and the hardware for the additional functionalities 50, 52, and 54, may be mounted on top of the elevator 10.

The self-contained wireless version of the pressure sensor 16′ can be manufactured to a length of seven (7) feet, which is the typical height of an elevator door. Such an embodiment can be easily mounted onto any elevator door 14 and once it is connected to a power source 39, can be activated by pressing an initialization button. Once the initialization button of a wireless version of the pressure sensor 16′ is pressed, the microprocessor 48 will cycle through the available frequencies (around 400 MHz) to detect any conflicts with other existing wireless devices in the vicinity. Each self-contained wireless version of the pressure sensor 16′ must have a distinct frequency so that each signal 26′ being sent to the master control system 30′ is distinctive.

Based on the construction disclosed, the pressure sensor 16 and 16′ of the present invention is very sensitive and can be activated with as little as 4 oz of weight.

The pressure sensor 16 and 16′ of the present invention may be used in connection with elevators having a single or multiple panels doors or other automatic door system.

The ease of mounting the pressure sensor 16 and 16′ of the present invention to an elevator door allows the use of the pressure sensor 16 and 16′ as a secondary, back-up, safety feature to any elevator door 14 that already has one of the prior art safety systems.

Although certain features of the invention have been illustrated and described herein, other better modifications and changes will occur to those skilled in the art. It is, therefore, to be understood that the appended claims are intended to cover all such modification and changes that fall within the spirit of the invention.

What we claim is:

1. A pressure sensor for an automatic door having a closing edge, comprising:
at least one film pressure sensor layer comprises two electrode films sandwiching a non-electrical conducting layer adapted to attach to at least a portion of the closing edge;
one or more first protective layer overlaying said at least one film pressure sensor layer defining a new closing edge of the door; and
means for generating a sensor signal when pressure is applied to said film pressure sensor layer such that said two electrode films come into contact with each other.

2. The pressure sensor of claim 1 further comprising at least one anti-penetration layer between said at least one film pressure sensor layer and said one or more first protective layer.

3. The pressure sensor of claim 1 further comprising at least one or more second protective layer, wherein said at least one film pressure sensor layer overlaying said one or more second protective layer such that said at least one or more second protective layer is adapted to secure to at least a portion of the closing edge of the door.

4. The pressure sensor of claim 1 further comprising means for fastening the pressure sensor to the closing edge of the door.

5. The pressure sensor of claim 1 further comprising means for adhering the pressure sensor to the closing edge of the door.

6. The pressure sensor of claim 1 wherein said one or more first protective layer is made of rubber.

7. The pressure sensor of claim 1 wherein said one or more first protective layer is made of soft neoprene.

8. The pressure sensor of claim 1 wherein said one or more first protective layer is made of vinyl.

9. The pressure sensor of claim 2 wherein said at least one anti-penetration layer is made of an anti-ballistic material.

10. The pressure sensor of claim 2 wherein said at least one anti-penetration layer is made of an anti-piercing material.

11. The pressure sensor of claim 3 wherein said at least one or more second protective layer is made of metal.

12. The pressure sensor of claim 1 wherein said non-electrical conducting layer contains a dielectric gel.

13. The pressure sensor of claim 1 wherein said non-electrical conducting layer contains an inert, non-corrosive, gas.

14. The pressure sensor of claim 1 wherein said film pressure sensor layer having opposite outer elongated edges further comprises a spacer at said opposite outer elongated edges to aid in sustaining the physical structure of said film pressure sensor layer.

15. The pressure sensor of claim 1 further comprising a film encapsulating said film pressure sensor layer.

16. The pressure sensor of claim 1 further comprising a pressure transfer element between said at least one film pressure sensor layer and said one or more first protective layer.

17. The pressure sensor of claim 1 wherein said pressure transfer element is made of hard elastomer.

18. The pressure sensor of claim 1 wherein said pressure transfer element is made of hard rubber.

19. The pressure sensor of claim 1 wherein said pressure transfer element is made of hard neoprene.

20. The pressure sensor of claim 16 wherein said one or more first protective layer encloses said pressure transfer element and said at least one film pressures sensor layer.

21. The pressure sensor of claim 1 wherein said one or more first protective layer having a outer convex surface defining a rounded and safer new closing edge of the door.

22. The pressure sensor of claim 16 wherein said one or more first protective layer having a outer convex surface and an inner concave surface, said pressure transfer element having first and second convex surfaces, and said first convex surface is correspondingly shaped and sized to said inner concave surface.

23. The pressure sensor of claim 22 wherein said pressure transfer element is correspondingly sized and shaped to overlay said film pressure sensor layer to provide effective transfer of pressure to said film pressure sensor layer from all angles.

24. An elevator with at least one automatic door, a pressure sensor forming the closing edge of the door, said elevator being controlled by a master control system, the pressure sensor comprising:
at least one film pressure sensor layer comprises two electrode films sandwiching a non-electrical conducting layer adapted to attach to at least a portion of the closing edge;
one or more first protective layer overlaying said at least one film pressure sensor layer defining a new closing edge of the door; and
means for generating a sensor signal when pressure is applied to said film pressure sensor layer such that said two electrode films come into contact with each other; and
means for communicating said sensor signal to the master control system to open the door.

25. The elevator of claim 24 wherein the pressure sensor further comprising means for amplifying said sensor signal before communicating said sensor signal to the master control system.

26. The elevator of claim 24 wherein the pressure sensor further comprising a microprocessing means to provide additional functionalities to said pressure sensor.

27. The elevator of claim 24 wherein the pressure sensor further comprising a display showing the status of the pressure sensor.

28. The elevator of claim 27 wherein said display comprises at least one LED.

29. The elevator of claim 24 wherein the pressure sensor further comprising means to relay connect the pressure sensor to the master control system.

30. The elevator of claim 26 wherein said microprocessing means provides status information of the pressure sensor.

31. The elevator of claim 26 wherein said microprocessing means provides diagnostic information of the pressure sensor.

32. The elevator of claim 24 wherein said communicating means comprises means for wireless communication.

33. The elevator of claim 24 wherein said communicating means comprise wires and cables.

34. The elevator of claim 32 wherein said pressure sensor further comprising a button to initialize said wireless communication means to locate available frequency.

35. A method of opening an automatic door having a pressure sensor forming the closing edge of the door, said door being controlled by a master control system, comprising the steps of:
providing at least one film pressure sensor layer comprises two electrode films sandwiching a non-electrical conducting layer;
providing one or more first protective layer overlaying said at least one film pressure sensor layer;
applying pressure to said film pressure sensor layer such that said two electrode films come into contact with each other;
providing means for generating a sensor signal when pressure is applied to said film pressure sensor layer such that said two electrode films come into contact with each other;
providing means for communicating said sensor signal to the master control system; and
the master control opening the door upon detecting said sensor signal.
